(19) United States
(12) Patent Application Publication
(10) Pub. No.: US 2026/0062234 A1
(43) Pub. Date: Mar. 5, 2026

(54) BARREL LIFT APPARATUS AND BARREL CONVEYANCE APPARATUS

(71) Applicant: LINE-INDUSTRY Co.,Ltd., Komaki-shi (JP)

(72) Inventor: Kenji NAKAI, Komaki-shi (JP)

(21) Appl. No.: 19/316,040

(22) Filed: Sep. 2, 2025

(30) Foreign Application Priority Data
Sep. 3, 2024 (JP) 2024-151233

(51) Int. Cl. B65G 47/91

(52) U.S. Cl. CPC B65G 47/912; B65G 2201/0241

(57) ABSTRACT

A barrel lift apparatus to be used for lifting a barrel. The barrel lift apparatus includes a contact plate, a suction unit, and a lifting/lowering unit. The contact plate is mounted with an annular member having elasticity, the annular member being configured to be brought into contact with an outer circumferential edge of an upper surface of a barrel that is in an upright state. The suction unit is configured to suction an inside of a contact portion between the annular member and the outer circumferential edge of the upper surface of the barrel to suction-hold the barrel to the contact plate. The lifting/lowering unit is configured to move, in upward and downward directions, the contact plate to which the barrel has been suction-held by the suction unit.

### CROSS-REFERENCE TO RELATED APPLICATION

This application claims priority from Japanese Patent Application No. 2024-151233 filed with the Japan Patent Office on Sep. 3, 2024, the entire content of which is hereby incorporated by reference.

### BACKGROUND

### 1. Technical Field

The present invention relates to a barrel lift apparatus to be used for conveying a barrel such as a whiskey barrel or a wine barrel and a barrel conveyance apparatus in which the barrel lift apparatus is used.

### 2. Related Art

Barrels (columnar containers having, in a height direction thereof, middle portions bulged outward) made of wood are widely used as storage containers for liquors such as whiskey, wine, and beer. At the time of conveying each of such barrels containing liquors, a method in which the barrel is laterally laid down (with a longitudinal direction thereof being a horizontal direction) and is rolled in this state has been employed. Meanwhile, at the time of storage or the like, the barrel is unstable when being kept in the laid-down state, and thus is brought into an upright state (a state where the longitudinal direction is a vertical direction) in many cases. Therefore, if the barrel can be conveyed while being kept in an upright state, work such as storage, production, and shipping of the liquor contained in the barrel is facilitated.

As an apparatus in which a barrel is thus conveyed while being kept in an upright state, a conveyance apparatus (barrel-type container conveyance vehicle) is known as in JP-A-H6-115892. The conveyance apparatus includes a frame member having a U shape in a plan view. The frame member has right and left end edges at which a pair of right and left arc-shaped support members (arms) for gripping the side surface of a barrel is disposed in an openable/closable manner.

However, in the conveyance apparatus in JP-A-H6-115892, the pair of right and left support members need to be caused to approach the side surface of a barrel from outer sides. Consequently, it takes the support members a long time to grip (sandwich) the barrel therebetween, and furthermore, in a case where a plurality of barrels to be conveyed are placed on a pallet or the like, the barrels have to be placed with gaps therebetween. Thus, this conveyance apparatus has a disadvantage in that conveyance efficiency is poor. In addition, such barrels containing liquors are not necessarily unified in terms of the sizes and the shapes thereof, and barrels having various sizes and shapes exist. Thus, there is a concern that a barrel cannot be gripped with sufficient strength so that the barrel might be dropped or turned over when being lifted, depending on the shape of the barrel.

An object of the present invention is to provide a barrel lift apparatus and a barrel conveyance apparatus that solve the problems of barrel conveyance apparatuses such as the above-described conveyance apparatus in JP-A-H6-115892 and that allow barrels to be conveyed efficiently in a short time and reliably without any failure regardless of variation in size and shape among the barrels.

### SUMMARY

The invention according to a first aspect among the present inventions is a barrel lift apparatus to be used for lifting a barrel (examples of the barrel include all of barrel-shaped objects such as whiskey barrels, wine barrels, and beer barrels), the barrel lift apparatus including: a contact plate mounted with an annular member having elasticity, the annular member being configured to be brought into contact with an outer circumferential edge (ring-shaped protrusion) of an upper surface of a barrel that is in an upright state; a suction unit configured to suction an inside of a contact portion between the annular member and the outer circumferential edge of the upper surface of the barrel to suction-hold the barrel to the contact plate; and a lifting/lowering unit configured to move, in upward and downward directions, the contact plate to which the barrel has been suction-held by the suction unit. The barrel in the present invention is not limited to a barrel having an upper surface whose outer circumferential edge is raised beyond the other portions of the barrel to be formed as a ring-shaped protrusion. Examples of the barrel also include a barrel having a flat upper surface.

In the invention according to a second aspect, which is in the invention according to the first aspect, the annular member is formed from neoprene rubber.

In the invention according to a third aspect, which is in the invention according to the first aspect, the suction unit includes a blower.

The invention according to a fourth aspect is a barrel conveyance apparatus to be used for conveying a barrel, the barrel conveyance apparatus including: the barrel lift apparatus according to any one of the first to third aspects; and a movement unit configured to move, within a horizontal plane, the contact plate in a state where the barrel elevated by the lifting/lowering unit is suction-held to the contact plate.

The barrel lift apparatus according to the first aspect includes: a contact plate mounted with an annular member configured to be brought into contact with an outer circumferential edge of an upper surface of a barrel; a suction unit configured to suction-hold the barrel to the contact plate; and a lifting/lowering unit configured to move, in upward and downward directions, the contact plate to which the barrel has been suction-held. Consequently, when the annular member of the contact plate is pressed against the outer circumferential edge of the upper surface of the barrel and the inside of this annular member is suctioned, the barrel can be firmly suction-held to the contact plate by utilizing suctioning force. In this state, the barrel can be lifted and lowered together with the contact plate. Therefore, the barrel lift apparatus according to the first aspect enables the barrel to be efficiently conveyed in a short time in an upright state regardless of the size of the barrel.

In the barrel lift apparatus according to the second aspect, the annular member is formed from neoprene rubber. Consequently, the barrel can be more firmly suction-held to the contact plate, whereby the barrel can be reliably conveyed with high accuracy in an upright state without allowing occurrence of a trouble such as dropping. In addition, the annular member exhibits an appropriate extent of elasticity. Thus, an allowable range of a height position at which the contact plate is brought into contact with (pressed against) the outer circumferential edge of the upper surface of the barrel (an allowable range of a height position at which the barrel is not damaged owing to excessive pressure) is wide, whereby a system for automatically conveying barrels can be easily established.

In the barrel lift apparatus according to the third aspect, the suction unit includes a blower. Consequently, the barrel can be firmly suction-held to the contact plate in a shorter time, whereby the barrel can be reliably conveyed with high accuracy in an upright state without allowing occurrence of a trouble such as dropping.

The barrel conveyance apparatus according to the fourth aspect includes a movement unit configured to move, within a horizontal plane, the contact plate in a state where the barrel is suction-held to the contact plate. Consequently, the barrel can be efficiently conveyed in a short time in an upright state regardless of the size and the shape of the barrel.

### BRIEF DESCRIPTION OF DRA WINGS

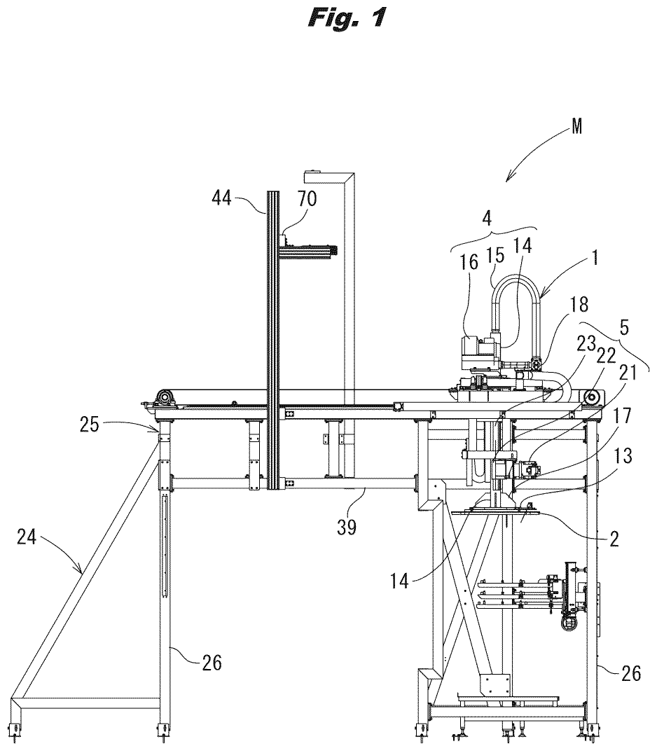

FIG. 1 is an explanatory view (front view) illustrating a barrel conveyance apparatus;

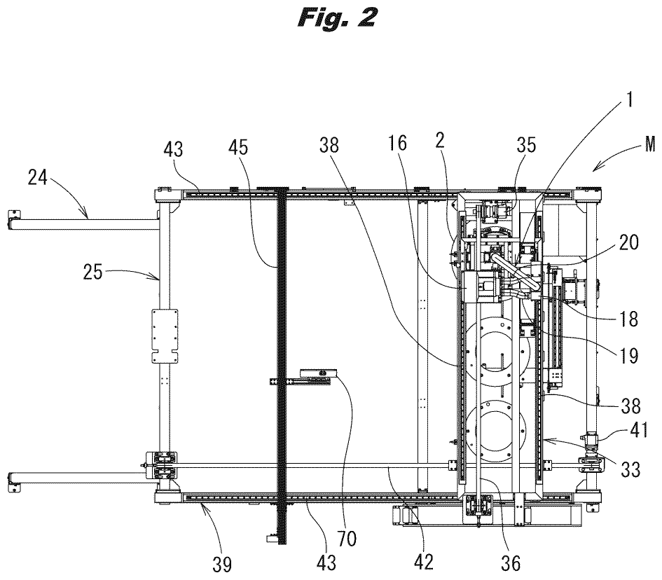

FIG. 2 is an explanatory view (plan view) illustrating the barrel conveyance apparatus;

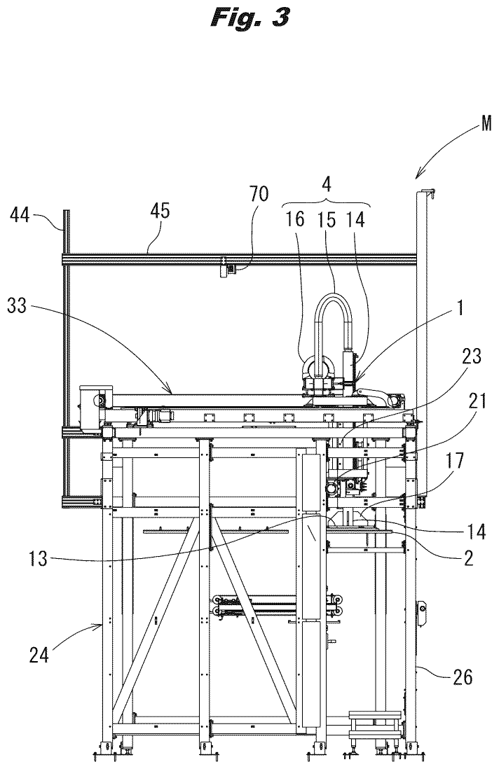

FIG. 3 is an explanatory view (right side view) illustrating the barrel conveyance apparatus;

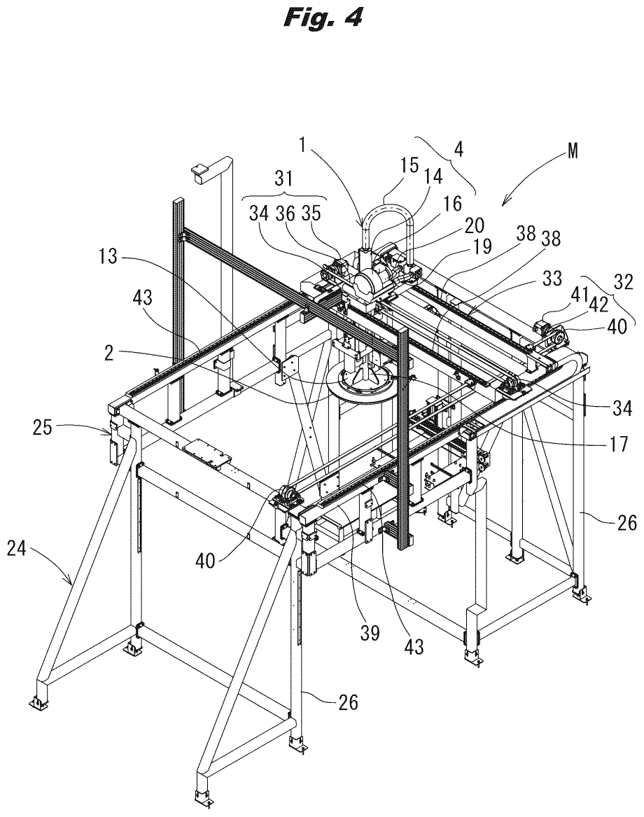

FIG. 4 is an explanatory view (perspective view as seen from above) illustrating the barrel conveyance apparatus;

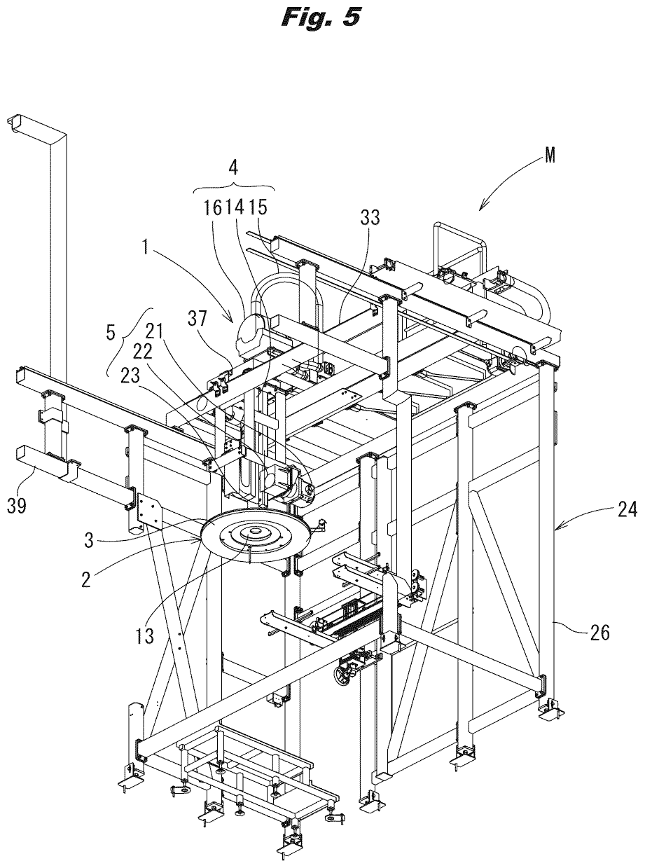

FIG. 5 is an explanatory view (perspective view as seen from below) illustrating the barrel conveyance apparatus;

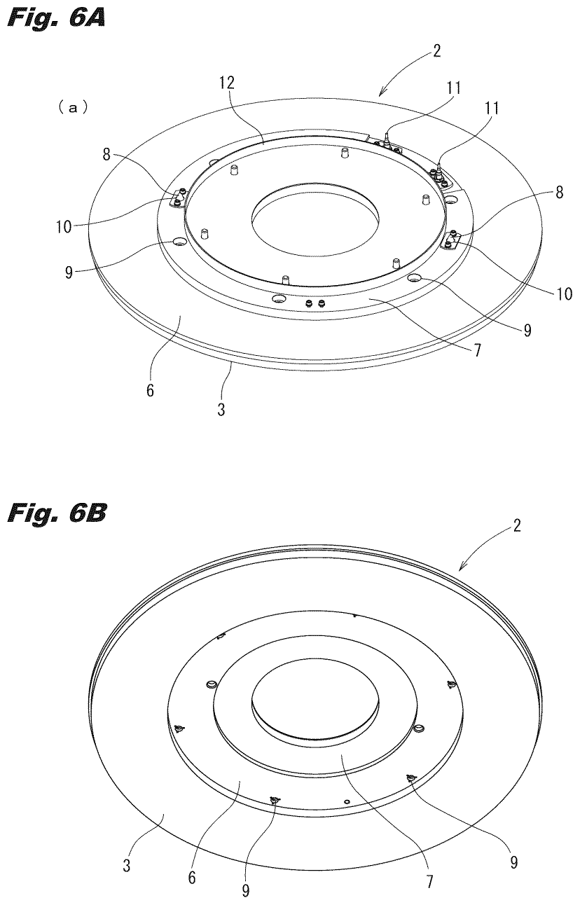

FIGS. 6A and 6B are explanatory views illustrating a contact plate of a barrel lift apparatus (FIG. 6A is a perspective view of the front surface side of the contact plate, and FIG. 6B is a perspective view of the back surface side of the contact plate);

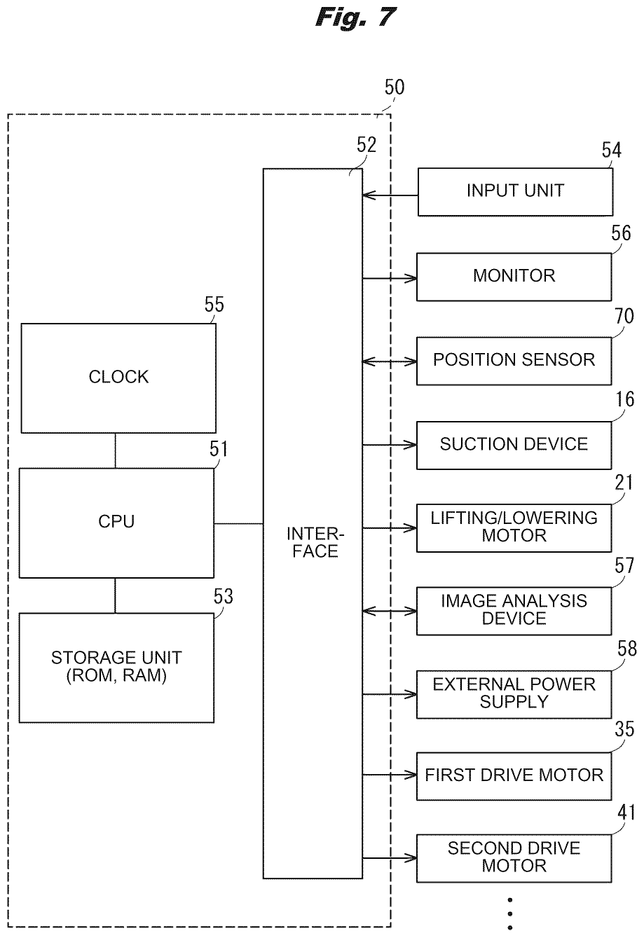

FIG. 7 is a block diagram illustrating a control mechanism of the barrel conveyance apparatus;

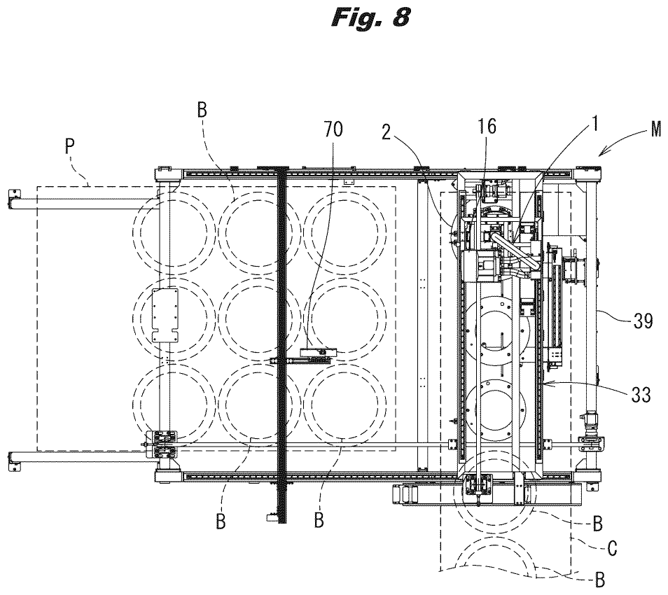

FIG. 8 is an explanatory view (plan view) illustrating an operation procedure for the barrel conveyance apparatus; and

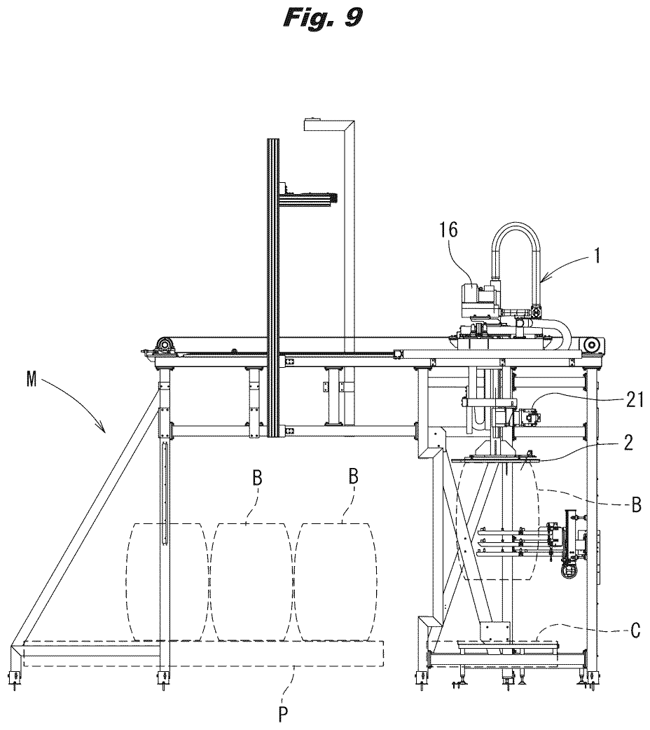

FIG. 9 is an explanatory view (front view) illustrating the operation procedure for the barrel conveyance apparatus.

### DETAILED DESCRIPTION

### <Configurations of Barrel Lift Apparatus and Barrel Conveyance Apparatus>

Hereinafter, a barrel lift apparatus and a barrel conveyance apparatus according to an embodiment of the present invention will be described in detail with reference to the drawings. FIG. 1 to FIG. 5 illustrate the barrel conveyance apparatus including the barrel lift apparatus. A barrel conveyance apparatus M includes: a barrel lift apparatus 1 that suction-holds a barrel (whiskey barrel), and lifts and lowers the barrel in upward and downward directions; a movement unit 30 that moves, within a horizontal plane, the barrel lifted by the barrel lift apparatus 1; a position sensor (camera) 70 that senses a position of the barrel placed in an upright state on a floor surface or a pallet; a control device (control unit) 50 that operates the barrel lift apparatus 1 and the movement unit 30 based on a sensing result from the position sensor 70; and the like.

The barrel lift apparatus 1 is composed of: a contact plate 2 mounted with an annular member 3 having elasticity, the annular member 3 being configured to be brought into contact with an outer circumferential edge (ring-shaped protrusion) of an upper surface of a barrel B that is in an upright state; a suction unit 4 that suctions an inside of a contact portion between the annular member 3 and the ring-shaped protrusion of the upper surface of the barrel B to suction-hold the barrel to the contact plate 2; a lifting/lowering unit 5 that moves, in the upward and downward directions, the contact plate 2 to which the barrel has been suction-held by the suction unit 4; and the like.

FIGS. 6A and 6B illustrate the contact plate 2. The contact plate 2 includes: an attachment 6 that is a toric metal plate having predetermined outer and inner diameters (outer diameter=900 mm, inner diameter=400 mm); and a mounting plate 7 that is a toric metal plate having smaller diameters than the attachment 6, and onto which the attachment 6 has been detachably and concentrically screwed by using a plurality of bolts. The attachment 6 mounted to the contact plate 2 illustrated in FIGS. 6A and 6B is used for lifting and lowering an ordinary-size barrel (with the upper surface thereof having an outer diameter of about 600 to 810 mm and a height of about 1,000 to 1,450 mm).

Two substantially conical positioning protrusions 8 that position the attachment 6 at the time of screwing the attachment 6 onto the mounting plate 7 are left-right symmetrically provided to vicinities of the inner circumferential edge of the front surface of the attachment 6. Also, the annular member 3 having a toric shape (the shape of a flat thick cylinder) is fastened to a vicinity of the outer circumferential edge of the back surface of the attachment 6. The annular member 3 is formed from neoprene rubber having a density of about 0.15 (0.15±0.03), a hardness (type C) of about 15 (15±5), and a 25% compressive load of about 50 kPa (50±15), and has predetermined outer and inner diameters (outer diameter=about 890 mm, inner diameter=about 550 mm) and a predetermined thickness (about 20 mm). The annular member 3 formed from such neoprene rubber is fastened (stuck) to the back surface of the attachment 6 by using double-sided tape in a state where the outer circumferential edge of the annular member 3 coincides with the outer circumferential edge of the attachment 6.

In addition, the barrel lift apparatus 1 includes, in addition to the above-described attachment 6 to be used for lifting and lowering the ordinary-size barrel, a small-size attachment (not illustrated) to be used for lifting and lowering a small-size barrel (with the upper surface thereof having an outer diameter of about 520 to 670 mm and a height of about 750 to 990 mm). The attachment 6 can be replaced with the small-size attachment according to the barrel to be lifted and lowered. The small-size attachment is formed in such a toric shape (outer diameter=about 700 mm, inner diameter=about 400 mm) as to be a little smaller than the attachment 6, and an annular member having such a toric shape (the shape of a flat thick cylinder) as to be a little smaller than the annular member 3 of the attachment 6 is fastened to the small-size attachment.

In each of vicinities of the outer circumferential edges of the mounting plate 7, six screw holes 9 for screwing the attachment 6 are drilled at equiangular intervals (intervals of) 60° around the center, and two positioning holes 10 for positioning the attachment 6 at the time of screwing the attachment 6 are left-right symmetrically drilled. A vicinity of the outer circumferential edge of the front surface of the mounting plate 7 is provided with two pressure sensors 11 that sense the internal pressure (degree of vacuum) of a closed space when suction is performed with the outer circumferential edge (ring-shaped protrusion) of the upper surface of a barrel being pressed against the annular member 3. Furthermore, inward of the screw holes 9, the positioning holes 10, and the pressure sensors 11, a flat annular mounting wall 12 for positioning at the time of screwing onto a support plate 13 of the suction unit 4 is disposed upright concentrically about the center. In a case where the ordinary attachment 6 is attached to the mounting plate 7, the two pressure sensors 11 sense the internal pressure. Meanwhile, in a case where the small-size attachment is attached to the mounting plate 7, only one of the pressure sensors 11 senses the internal pressure.

The suction unit 4 is composed of a suction path forming member 14, a suction pipe 15, a blower 16 as a suction device, and the like. The suction path forming member 14 is formed in the shape of an elongated hollow tube (with the upper side thereof having the shape of a hollow quadrangular prism and with the lower side thereof having a cylindrical shape) and is vertically disposed. The suction path forming member 14 has a lower end at which the support plate 13 having a circular shape is disposed perpendicular to the longitudinal direction of the suction path forming member 14. To vicinities of the lower end of the suction path forming member 14, four reinforcement pieces 17 are vertically attached at equiangular intervals (intervals of) 90° around the center of the suction path forming member 14 to be in contact with both the suction path forming member 14 and the support plate 13. The suction path forming member 14 has an upper end to which the suction pipe 15 substantially having a U shape is connected. The suction pipe 15 has an end that is in a state of having been connected to the blower 16 via a connection member 18. The blower 16 is a so-called side channel blower (a blower having a double-stage structure with one cylinder) and includes: an intake pipe 19 connected to the suction pipe 15 via the connection member 18; and a discharge pipe 20.

The lifting/lowering unit 5 is composed of: a lifting/lowering motor (stepping motor) 21; a pinion gear 22 mounted to a rotation shaft of the lifting/lowering motor 21; a rack 23 fastened to the outer surface of the suction path forming member 14; and the like. By supplying external power to the lifting/lowering motor 21, the rack-and-pinion mechanism can move, vertically upward and downward, the suction path forming member 14 to which the contact plate 2 has been fastened.

In the barrel conveyance apparatus M, the barrel lift apparatus 1 configured as described above is assembled to a base frame 24, and the movement unit 30 can move, within the horizontal plane, the contact plate 2 in a state where a barrel is suction-held and lifted by the contact plate 2.

The base frame 24 has a structure in which an upper frame member 25 assembled in a flat rectangular shape is supported by a plurality of vertical support pillars 26. The upper frame member 25 is mounted with the movement unit 30 that moves, within the horizontal plane, the contact plate 2 to which a barrel has been suction-held. The movement unit 30 is composed of: a front-rear-direction movement mechanism 31 that moves the barrel lift apparatus 1 in front-rear directions (Y-axis directions); and a left-right-direction movement mechanism 32 that moves the barrel lift apparatus 1 in left-right directions (X-axis directions).

The front-rear-direction movement mechanism 31 is composed of: a movement frame member 33 elongated frontward and rearward; a pair of sprockets 34 rotatably and pivotally attached at front and rear positions on the movement frame member 33; a first drive motor (stepping motor) 35 that performs drive in the Y-axis directions to rotate the sprocket 34 on one side (rear side); a chain 36 suspended between the pair of sprockets 34; a fixation mount 37 provided on the movement frame member 33 to be movable in the front-rear directions; and the like. The barrel lift apparatus 1 is fastened to the fixation mount 37.

When external power is supplied to the first drive motor 35, the chain 36 is moved, whereby the fixation mount 37 fastened to the chain 36 is moved frontward and rearward. The movement frame member 33 is composed of a pair of right and left elongated frames on which guide rails 38 each based on a bearing mechanism are mounted. The fixation mount 37 slides on the guide rails 38 frontward and rearward, and thus can be moved (frontward and rearward) considerably smoothly at a constant speed.

The left-right-direction movement mechanism 32 is composed of: a fixation frame member 39 elongated leftward and rightward; a pair of sprockets 40 rotatably and pivotally attached at right and left positions on the fixation frame member 39; a second drive motor (stepping motor) 41 that performs drive in the X-axis directions to rotate the sprocket 40 on one side (left side); a chain 42 suspended between the pair of sprockets 40; the movement frame member 33 mounted on the fixation frame member 39 to be movable in the left-right directions; and the like.

When external power is supplied to the second drive motor 41, the chain 42 is moved, whereby the movement frame member 33 fastened to the chain 42 is moved leftward and rightward. The fixation frame member 39 is composed of a pair of front and rear elongated frames on which guide rails 43 each based on a bearing mechanism are mounted. The movement frame member 33 slides on the guide rails 43 leftward and rightward, and thus can be moved (leftward and rightward) considerably smoothly at a constant speed.

The upper frame member 25 of the base frame 24 is composed of a pair of front and rear elongated frames having respective centers. At positions slightly shifted leftward from these centers, respective support pillars 44 are disposed upright. Between vicinities of the upper ends of the support pillars 44, a horizontal frame 45 is suspended. The horizontal frame 45 has a center near which the position sensor 70 for sensing the position of a barrel placed in an upright state on a floor surface or a pallet is attached.

FIG. 7 illustrates the control device 50 of the barrel conveyance apparatus M. The control device 50 includes a CPU 51, an interface 52, a storage unit (a memory such as a RAM or ROM) 53, an input unit 54, a clock (timer) 55, and the like. The control device 50 is connected via the interface 52 to the blower (suction device) 16 of the suction unit 4 and the lifting/lowering motor 21 of the lifting/lowering unit 5 of the barrel lift apparatus 1, the first drive motor 35 and the second drive motor 41 of the movement unit 30, the position sensor 70, an image analysis device 57, an external power supply 58, a monitor 56, and the like. In the storage unit 53 of the control device 50, data of a conveyance order of various barrels placed on a pallet, data of a placement position on a belt conveyor for conveyance to the outside, and the like are stored.

### <Operation Procedure for Barrel Lift Apparatus and Barrel Conveyance Apparatus>

Hereinafter, an operation procedure for the barrel lift apparatus 1 and the barrel conveyance apparatus M described above will be described. FIG. 8 and FIG. 9 each illustrate a situation where a plurality of barrels (having various sizes and shapes) B placed on a pallet P carried into the barrel conveyance apparatus M are conveyed onto a carry-out conveyor C. In the barrel conveyance apparatus M, the control device 50 causes conveyance of the barrels B according to a conveyance program stored in the storage unit 53.

The conveyance of the barrels B by the barrel conveyance apparatus M is performed as follows. First, the position sensor 70 (camera) is actuated to sense a conveyance-target barrel B. The barrel conveyance apparatus M is configured to be able to specify, by using the input unit 54 of the control device 50, a conveyance order of the various barrels B placed on the pallet P. Then, when the position sensor 70 senses (takes an image of) the conveyance-target barrel, the image analysis device 57 performs image analysis on the taken image to identify a position (x₁ (left-right position), y₁ (front-rear position), and z₁ (height position)) of the center of the upper surface of the conveyance-target barrel B on the pallet P in the internal space of the base frame 24.

When the position (x₁, y₁, z₁) of the center of the upper surface of the conveyance-target barrel B is identified as described above, external power is supplied to the first drive motor 35 of the front-rear-direction movement mechanism 31 and the second drive motor 41 of the left-right-direction movement mechanism 32 of the movement unit 30 to move the contact plate 2 of the barrel lift apparatus 1 in the front-rear and left-right directions to the identified position (x₁, y₁) (i.e., move the contact plate 2 such that the center thereof coincides with the position (x₁, y₁)). Along with the movement of the contact plate 2 in the front-rear and left-right directions, external power is supplied to the lifting/lowering motor 21 of the lifting/lowering unit 5 of the barrel lift apparatus 1 to lower the contact plate 2 to a position that is higher than the height position (z₁) by a predetermined length (about 30 mm).

Then, when the contact plate 2 is moved to the position that is higher than the height position (z₁) of the center of the upper surface of the conveyance-target barrel B by the predetermined length (about 30 mm), external power is supplied to the blower (suction device) 16 of the suction unit 4 of the barrel lift apparatus 1 to suction-hold the upper surface of the barrel B. After the blower 16 starts the suction as well, the contact plate 2 continues to be lowered until the height position thereof reaches the identified position (z₁), whereby the annular member 3 is brought into contact with the outer circumferential edge (ring-shaped protrusion) of the upper surface of the barrel.

When the contact plate 2 is lowered to the vicinity of the upper surface of the barrel B and the blower 16 of the barrel lift apparatus 1 starts suction as described above, the pressure sensors 11 start sensing the inner pressure of a space closed by the lower surface of the contact plate 2, the annular member 3, and the upper surface of the barrel B (hereinafter, referred to as “suction space”). Then, when it is determined that the pressure being sensed has become a predetermined negative pressure (minus pressure), it is determined that the upper surface of the barrel B has been suction-held to the contact plate 2 by a high suctioning force. Then, external power is supplied to the lifting/lowering motor 21 of the barrel lift apparatus 1 to elevate (lift) the barrel B to a predetermined height position. Depending on the state of the barrel B being conveyed, there is a case where the annular member 3 of the contact plate 2 is not brought into close contact with the outer circumferential edge (ring-shaped protrusion) of the upper surface of the barrel B, and the pressure of the suction space does not become the predetermined negative pressure. However, in this case as well, when a predetermined time (e.g., 5 seconds) elapses from the start of the suction, external power is supplied to the lifting/lowering motor 21 of the barrel lift apparatus 1 to elevate the barrel B to the predetermined height position owing to the function of the clock (timer) 55.

Furthermore, when the contact plate 2 to which the barrel B has been suction-held is elevated to the predetermined height position, external power is supplied to the first drive motor 35 of the front-rear-direction movement mechanism 31 and the second drive motor 41 of the left-right-direction movement mechanism 32 of the movement unit 30 to move the contact plate 2 of the barrel lift apparatus 1 in the front-rear and left-right directions to a position (a predetermined position over the carry-out conveyor C=x₂, y₂) of a conveyance destination that is preset (stored in the storage unit 53) (i.e., move the contact plate 2 such that the center thereof coincides with the position (x₂, y₂)).

When the contact plate 2 combined with the barrel B is moved in the front-rear and left-right directions to the position (x₂, y₂) of the preset conveyance destination as described above, external power is supplied to the lifting/lowering motor 21 of the barrel lift apparatus 1 to lower the contact plate 2, to which the barrel B has been suction-held, to a height position (i.e., a predetermined height position over the carry-out conveyor C=z₂) of a conveyance destination that is preset (stored in the storage unit 53). During this lowering, when the contact plate 2 is moved to a position that is higher than the position (x₂, y₂, z₂) with respect to the center of the upper surface of the conveyance-target barrel B by a predetermined length (about 30 mm), the blower 16 of the barrel lift apparatus 1 stops the suction being performed on the upper surface of the barrel B to open the suction space and increase the inner pressure.

Then, when the suction space is thus opened, the suction-held state between the upper surface of the barrel B and the contact plate 2 is canceled, and the barrel B is placed at the preset position (x₂, y₂) on the carry-out conveyor C. Furthermore, after the barrel B is thus placed at the preset position over the carry-out conveyor C, external power is supplied to the lifting/lowering motor 21 of the barrel lift apparatus 1 to elevate the contact plate 2 of the barrel lift apparatus 1 to a predetermined height position, and external power is supplied to the first drive motor 35 and the second drive motor 41 of the movement unit 30 to move the contact plate 2 in the front-rear and left-right directions to a position (x₃, y₃) of the center of the upper surface of a barrel B that is on the pallet P and that is set as a next conveyance target (i.e., move the contact plate 2 such that the center thereof coincides with the position (x₃, y₃)). Then, the next conveyance-target barrel B is conveyed according to the same operation procedure as the above-described operation procedure.

### <Advantageous Effects of Barrel Lift Apparatus and Barrel Conveyance Apparatus>

As described above, the barrel lift apparatus 1 includes: the contact plate 2 mounted with the annular member 3 having elasticity, the annular member 3 being configured to be brought into contact with the outer circumferential edge (ring-shaped protrusion) of the upper surface of a barrel B that is in an upright state; the suction unit 4 (blower 16) that suctions the inside of the contact portion between the annular member 3 and the ring-shaped protrusion of the upper surface of the barrel B to suction-hold the barrel B to the contact plate 2; and the lifting/lowering unit 5 that moves, in the upward and downward directions, the contact plate 2 to which the barrel B has been suction-held by the suction unit 4. Consequently, in the barrel lift apparatus 1, when the annular member 3 of the contact plate 2 is pressed against the outer circumferential edge of the upper surface of the barrel B and the inside (suction space) of this annular member 3 is suctioned, the barrel B can be firmly suction-held to the contact plate 2 by utilizing suctioning force. In this state, the barrel B can be lifted and lowered together with the contact plate 2. Therefore, the barrel lift apparatus 1 enables the barrel B to be efficiently conveyed in a short time in an upright state regardless of the size of the barrel B.

In addition, in the barrel lift apparatus 1, the annular member 3 is formed from neoprene rubber. Consequently, the barrel B can be more firmly suction-held to the contact plate 2, whereby the barrel B can be reliably conveyed with high accuracy in an upright state without allowing occurrence of a trouble such as dropping. In addition, the annular member 3 exhibits an appropriate extent of elasticity. Thus, an allowable range of a height position at which the contact plate 2 is brought into contact with (pressed against) the outer circumferential edge of the upper surface of the barrel B (an allowable range of a height position at which the barrel is not damaged owing to excessive pressure) is wide, whereby a system for automatically conveying barrels B can be easily established.

Furthermore, in the barrel lift apparatus 1, the suction unit 4 includes the blower 16 as a suction device. Consequently, the barrel B can be firmly suction-held to the contact plate 2 in a shorter time, whereby the barrel B can be reliably conveyed with high accuracy in an upright state without allowing occurrence of a trouble such as dropping.

The barrel conveyance apparatus M includes: the barrel lift apparatus 1; and the movement unit 30 that moves, within the horizontal plane, the contact plate 2 elevated in a state where the barrel B is suction-held to the contact plate 2. Consequently, the barrel B can be efficiently conveyed in a short time in an upright state regardless of the size and the shape of the barrel B.

### <Modifications of Barrel Lift Apparatus and Barrel Conveyance Apparatus>

The barrel lift apparatus according to the present invention is not limited at all to any of the aspects of the above-described embodiment, and the features such as the shapes, structures, sizes, and materials of the contact plate, the annular member, the suction unit, the lifting/lowering unit, and the like may be changed as necessary without departing from the gist of the present invention.

For example, the annular member of the barrel lift apparatus is not limited to an annular member formed from neoprene rubber as in the above-described embodiment and may be, for example, an annular member formed from an elastic synthetic resin other than neoprene rubber, such as silicon rubber or foamed polyurethane. Use of an annular member having a hardness (type C) of 10 to 20 and a 25% compressive load of 40 to 60 kPa as the annular member leads to an advantage that it is possible to further widen the allowable range of the height position at which a barrel is not damaged owing to excessive pressure when the contact plate is brought into contact with (pressed against) the outer circumferential edge of the upper surface of the barrel. In addition, the thickness of the annular member is not limited to 20 mm that is the thickness in the above-described embodiment, and may be changed as necessary. In the case of using an annular member having a hardness (type C) of 10 to 20 and a 25% compressive load of 40 to 60 kPa as described above, adjustment of the thickness thereof to 10 to 35 mm makes it possible to significantly widen the allowable range of the height position at which a barrel is not damaged owing to excessive pressure when the contact plate is brought into contact with the outer circumferential edge of the upper surface of the barrel. Thus, this adjustment is particularly preferable. In addition, the contact plate of the barrel lift apparatus is not limited to a contact plate in which the annular member has been stuck to the back surface of the attachment by using double-sided tape as in the above-described embodiment. The contact plate may be: a contact plate in which the annular member has been adhered on the back surface by using an adhesive; or a contact plate in which bolts and nuts or the like are used for screwing to penetrate a vicinity of the outer circumferential edge or a vicinity of the inner circumferential edge of the annular member.

Also, the suction unit of the barrel lift apparatus is not limited to a suction unit in which a blower is used as a suction device as in the above-described embodiment, and may be a suction unit in which a rotary pump or the like is used. In the case of using a blower as a suction device as in the above-described embodiment, the inside of the suction space can be caused to have a high negative pressure in a considerably short time, whereby the conveyance efficiency for a barrel can be made more favorable.

The barrel conveyance apparatus according to the present invention is not limited at all to any of the aspects of the above-described embodiment either, and the features such as the shapes and structures of the frame, the movement unit, the position sensor, the control device, and the like may be changed as necessary without departing from the gist of the present invention.

For example, the movement unit of the barrel conveyance apparatus is not limited to a movement unit in which a sprocket-chain mechanism is used as in the above-described embodiment, and may be, for example, a movement unit in which a mechanism other than a sprocket-chain mechanism is used. Also, the barrel conveyance apparatus is not limited to a barrel conveyance apparatus in which the position sensor (camera) and the image analysis device sense the position of a barrel having been carried in, as in the above-described embodiment. For example, the barrel conveyance apparatus may be changed to: a barrel conveyance apparatus in which an optical sensor senses the position of a barrel having been carried in; or a barrel conveyance apparatus in which a position sensor obtained by combining the camera and the optical sensor senses the position of a barrel having been carried in.

Furthermore, the barrel conveyance apparatus is not limited to a barrel conveyance apparatus for conveying a barrel on a pallet onto a belt conveyor as in the above-described embodiment. For example, the barrel conveyance apparatus may be: a barrel conveyance apparatus for conveying a barrel on a belt conveyor onto another belt conveyor; or a barrel conveyance apparatus for conveying a barrel on a belt conveyor onto a pallet. In addition, the barrel conveyance apparatus is not limited to a barrel conveyance apparatus whose conveyance operation is controlled by the control device as in the above-described embodiment, and may be a barrel conveyance apparatus to be manually operated by a worker.

### INDUSTRIAL APPLICABILITY

The barrel lift apparatus according to the present invention exhibits excellent advantageous effects as described above, and thus is preferably usable as an apparatus for lifting and lowering a barrel in order to convey the barrel. Also, the barrel lift apparatus according to the present invention is preferably usable as an apparatus for efficiently and automatically conveying a barrel in an upright state.

### DESCRIPTION OF REFERENCE SIGNS

1: barrel lift apparatus
2: contact plate
3: annular member
4: suction unit
5: lifting/lowering unit
16: blower (suction device)
21: lifting/lowering motor
M: barrel conveyance apparatus
30: movement unit
35: first drive motor
41: second drive motor

What is claimed is:

1. A barrel lift apparatus to be used for lifting a barrel, the barrel lift apparatus comprising:
a contact plate mounted with an annular member having elasticity, the annular member being configured to be brought into contact with an outer circumferential edge of an upper surface of a barrel that is in an upright state;
a suction unit configured to suction an inside of a contact portion between the annular member and the outer circumferential edge of the upper surface of the barrel to suction-hold the barrel to the contact plate; and
a lifting/lowering unit configured to move, in upward and downward directions, the contact plate to which the barrel has been suction-held by the suction unit.

2. The barrel lift apparatus according to claim 1, wherein
the annular member is formed from neoprene rubber.

3. The barrel lift apparatus according to claim 1, wherein
the suction unit includes a blower.

4. A barrel conveyance apparatus to be used for conveying a barrel, the barrel conveyance apparatus comprising:
the barrel lift apparatus according to claim 1; and
a movement unit configured to move, within a horizontal plane, the contact plate in a state where the barrel is suction-held to the contact plate.
